(19) United States
(12) Patent Application Publication
(10) Pub. No.: US 2017/0324835 A1
(43) Pub. Date: Nov. 9, 2017

(54) METHOD AND SYSTEM FOR SHARING MULTIMEDIA CONTENTS THROUGH A TELECOMMUNICATION NETWORK

(71) Applicant: SNAPPYFAME LLC, Wilmington, DE (US)

(72) Inventor: Valerio PASTORE, Milano (IT)

(21) Appl. No.: 15/525,904

(22) PCT Filed: Nov. 12, 2014
(86) PCT No.: PCT/IT2014/000301

§ 371 Date: May 10, 2017

(51) Int. Cl. H04L 29/08; H04L 12/58

(52) U.S. Cl. CPC H04L 67/325; H04L 51/32

(57) ABSTRACT

A method shares multimedia contents among users through a telecommunication network. Each user is associated to a respective portable device with a module for connection to the telecommunication network. An application program is stored into firmware of each portable device and interoperates with a service center equipment program for management of the multimedia contents sharing service among the users and connects to the telecommunication network and connects devices to the processing equipment. Time sequences, including first and second time intervals are cyclically generated. A synchronization signal indicative of a first time sequence is sent to the portable devices. Multimedia contents are sent to the processing equipment during the first time interval of the first sequence through the synchronized portable device. A multimedia content specimen is selected during the second time interval and made available on the portable devices connected during a respective first time interval of a second time sequence.

### APPLICATION FIELD

The present description relates to a methodology for sharing multimedia contents among users through a telecommunication network.

Particularly, though not being limited thereto, the present description relates to a method and a system suitable to allow users provided with a portable electronic device to share and select pictures, videos and similar multimedia contents through the Internet.

### STATE OF THE ART

The increasing diffusion of portable electronic devices, such as for example, smartphones, tablets, laptops and the like, which are provided with electronic modules for data transfer to the Internet wireless network, through dedicated access points (according to the Wi-Fi communication standard) or through the mobile networks (according to the third 3G or fourth 4G generation communication standards) allows an increasing number of users to access web sites of particular interest while moving at any time of the day.

Moreover, since almost all such portable devices are also provided with respective digital image acquisition units, cameras o video cameras, each user is able to acquire through them an image or a video and to make it available, through Internet, for example in attachment to an e-mail, to other users, relatives or friends provided with similar portable devices. In other words, every user is able to share the multimedia content on-line with other users.

Such technological evolution of the telecommunication systems fostered, in the last years, the origin and the quick diffusion of several “social network” services, i.e. computer structures configured to manage networks based on social relationships in the Web. For example, such structures are identified by means of the reference web site of the social network.

To join a social network in Internet, each user first builds his/her personal profile and associates it to information and data suitable to identify the user himself in an unambiguous way, for example, through an e-mail address, up to characterize the profile stating respective interests, passions, work experiences, etc. In other words, the user registers himself/herself into the social network. Following such registration step, the user is able to create his/her contact network by inviting his/her friends or acquaintances to join his/her network in the social network, and establishing with each one of them a “link” to his/her registered profile. In such a way, virtual online communities of registered users are established in the social network, who share the same passions or interests.

Some of the more widespread social network systems or services, such as for example FACEBOOK, provide the users belonging to the same online community with functionalities of sharing pictures, videos or similar multimedia contents. Particularly, any user, or first user registered in the social network can, once he/she has taken a photo, for example, with his/her portable device, upload it in his/her profile by connecting to the social network via the Internet. In such a way, the photo is made available to all the users who, in addition to being registered in the same social network, are also connected with a respective “link” to the profile of the first user who uploaded it.

To access the photo available on the profile of the first user, a second user, who makes use of a connection to the Internet, for example through a smartphone, is required to register in the social network by creating his/her profile. The second user then asks the first user for an authorization to access his/her profile, i.e. to join the same online community. Only after the first user has given such an authorization, i.e. after a “link” is established between the profile of the first user and the profile of the second one, the latter is able to display the picture made available by the first user.

Such a method for sharing multimedia contents through Internet provided by the known social networks is not without drawbacks.

Indeed, the fruition of the multimedia content among the users always implies a few user registration steps in the social network to create the respective profile. Moreover, an authentication step is required between the user who makes the multimedia content available and the user asking to be able to access it.

Such registration and authentication steps are often time consuming because they require long data input steps from the users, which slow down the sharing of multimedia contents among users through the Internet.

### SUMMARY

The object of the present description is to provide a method for sharing multimedia contents among users through a telecommunication network, which is improved in order to solve at least partially the drawbacks described herein with reference to the known solutions thus allowing a faster circulation of multimedia contents among the users.

Such object is achieved by means of a method for sharing multimedia contents according to claim 1 and by means of the relative system implementing such method according to claim 18.

In addition, an object of the description is to provide a method for sharing multimedia contents among users, particularly, through the Internet, which by means of avoiding steps of registration and/or authentication by the users to access the multimedia contents sharing service, i.e. avoiding the corresponding long and laborious data insertion steps by the users, results to be less complex than the known methods.

Further advantageous embodiments of such method are defined in the dependent claims.

### BRIEF DESCRIPTION OF THE DRAWINGS

Further characteristics and advantages of the method for sharing multimedia contents disclosed herein, will appear from the description below of preferred embodiments thereof, which are given as indicative and not-limiting examples, with reference to the appended figures, where:

FIG. 1 schematically depicts a block diagram of an example of system suitable to implement the method for sharing multimedia contents among users through a telecommunication network of the present description;

FIG. 2 schematically depicts a block diagram of an example of processing equipment for use in the system of FIG. 1;

FIG. 3 depicts an example of flow chart of the method for sharing multimedia contents according to a general embodiment of the solution proposed herein;

FIGS. 4A, 4B depict examples of Graphical User Interface (GUI) for sharing multimedia contents according to one embodiment of the solution.

### DETAILED DESCRIPTION

In the above-mentioned figures, equal or similar elements are indicated by the same numeral references.

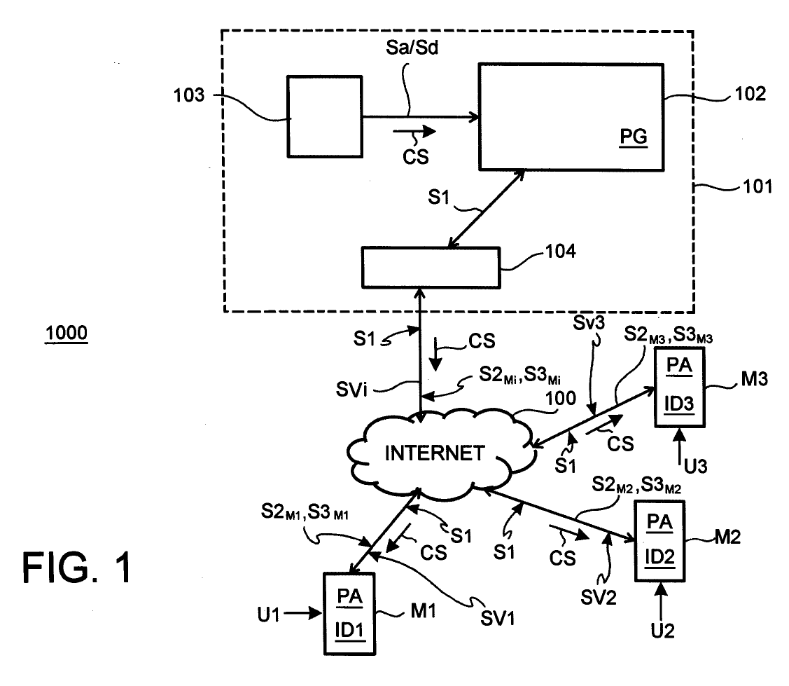

With reference to FIG. 1, a block diagram of an example of system suitable to implement the method for sharing multimedia contents of the present description among a plurality of users U1, U2, U3 through a telecommunication network 100 is generally indicated by the numeral reference 1000.

In an embodiment, such a telecommunication network is, for example, the Internet 100.

In the description below reference will be made to the term “multimedia content” to generally designate photos, videos or similar contents, which can be shared among multiple users U1, U2, U3 through the methodology described below.

Particularly, the system 1000 comprises a plurality of portable devices M1, M2, M3, each associated to a respective user U1, U2, U3. Each portable device M1, M2, M3 is configured to connect to the Internet 100. For this aim, for example, the portable devices M1, M2, M3 are provided with data transfer modules to the Internet in wireless mode through dedicated access points (according with the Wi-Fi communication standard) and/or with respective modules allowing the data transfer through the mobile networks (for example, according to lo third 3G or fourth 4G generation communication standard).

Moreover, such portable devices M1, M2, M3 are also provided with respective digital image acquisition units, for example cameras and/or video cameras.

Such portable devices M1, M2, M3 can be, for example: smartphones, tablets, laptops and other devices provided with similar features.

The system 1000 further comprises a processing equipment 102, particularly a server equipment, associated to a service center 101 for the management of the sharing service of multimedia contents among the users U1, U2, U3. Such service center 101 is schematically shown, in FIG. 1, by the dashed box.

Said processing equipment 102 is connectable to the Internet 100 through an electronic router device 104, included in the service center 101, which is known to those skilled in the art.

Additionally, the processing equipment 102 is configured to interface with a multimedia contents selection unit 103 of the service center 101. In an exemplary embodiment, such a selection unit 103 is embodied by a processing unit, particularly a personal computer, added to the processing equipment 102 and adapted to operate autonomously based on a respective pre-installed program.

In another exemplary embodiment, the selection unit 103 is embodied by a processing unit configured to perform operations in response to commands inputted by an operator.

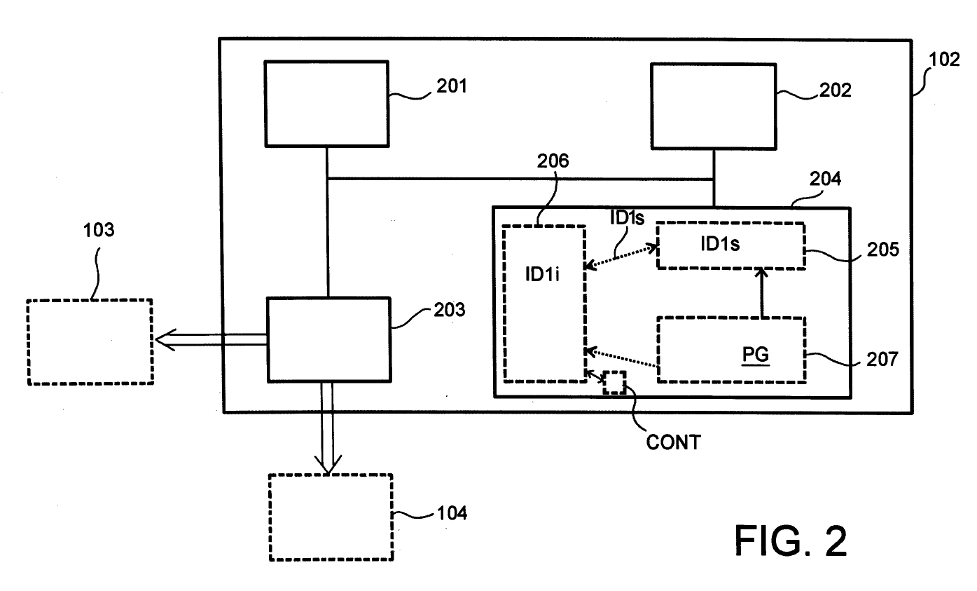

FIG. 2 shows a block diagram of an example of processing equipment 102 that can be used to implement the embodiments of the method described herein.

Particularly, the processing equipment 102 comprises a processing unit or microprocessor 201, an operative system 202, for example Windows O.S., a memory unit 204 and an input/output interface 203 operatively connected to both the router 104 and the multimedia contents selection unit 103 of the service center 101.

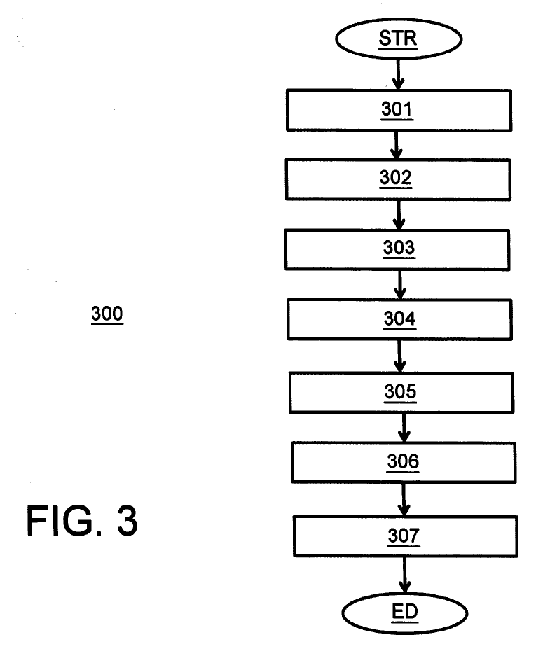

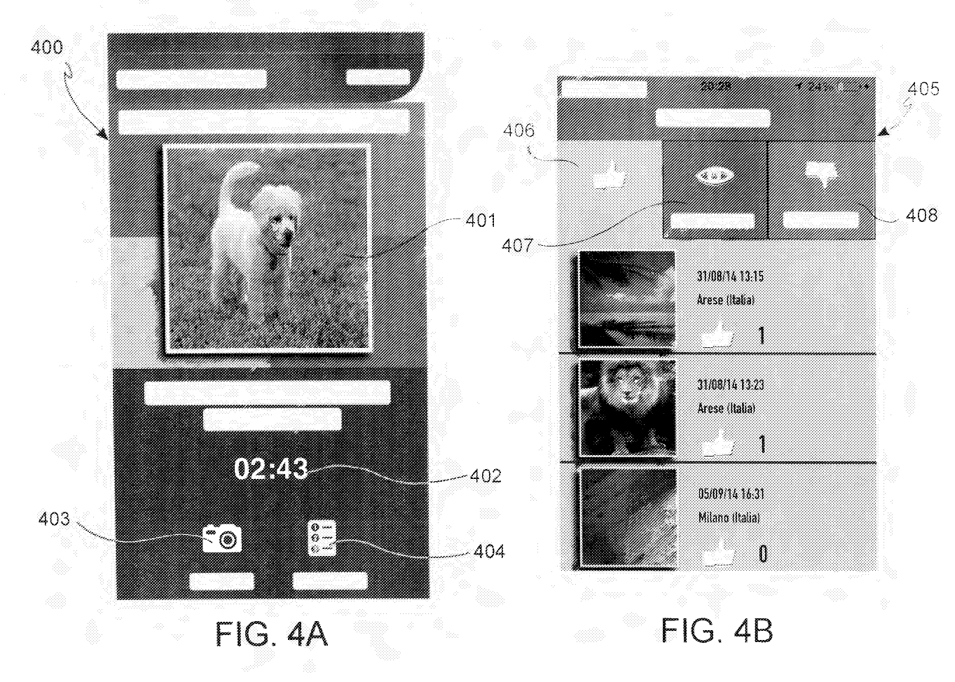

Starting from the aforementioned structural characteristics of the system 1000, with reference to the flow chart of FIG. 3 and to the user interfaces of FIGS. 4A-4B, a preferred embodiment of the method for sharing multimedia contents among the plurality of users U1, U2, U3, each of which is associated to a respective portable device M1, M2, M3 through the Internet 100 will be described below.

The proposed method 300 comprises a symbolic starting step STR.

The method 300 comprises a step 301 of storing an application program PA in a firmware of each portable device M1, M2, M3. Particularly, such an application program PA is adapted to interoperate with a first application program PG stored in the memory unit 204 of the processing equipment 102.

In an exemplary embodiment, such a storing step 301 also comprises two further steps which are performed only once for each portable device M1, M2, M3.

Particularly, a first step of downloading the application program PA by each user U1, U2, U3 from an online virtual shop of applications, music, books and the like on the respective portable device M1, M2, M3.

It should be noted that such online virtual shop of applications, music, books and the like is chosen, for example, in the group of:
Google Play Store;
Mac App Store;
Windows Store.

Moreover, the storing step 301 of the proposed method 300 comprises a step of enabling such a downloaded application program PA based on an enabling signal S2_{Mi} (with i=1, 2, 3) sent from the portable devices M1, M2, M3 to the processing equipment 102.

In a particular embodiment, such step of enabling the application program PA comprises a further step of making available to the processing equipment 102 an univocal identification IDi (with i=1, 2, 3) of each portable device M1, M2, M3 through said enabling signal S2_{Mi}. For example, such univocal identification IDi corresponds to the IMEI (International Mobile Equipment Identity) code, i.e. the numeric code univocally identifying a mobile terminal.

Such identification IDi of the portable devices M1, M2, M3 is stored by the processing equipment 102, particularly in the memory unit 204.

The invention method 300 then comprises an execution step 302 of the application program PA stored in each portable device M1, M2, M3, for example following a start command given by each user U1, U2, U3. For example, each user starts the application program PA by acting on an icon identifying such a program in the user interface of his/her portable device in order to connect such a device to the processing equipment 102 through the Internet 100.

In an embodiment, the method 300 provides for a cyclic generation step 303 by the processing equipment 102 of a plurality of time sequences SEQ1, SEQ2, . . . , SEQN, each of which sequentially comprises a first time interval T1 and a second time interval T2.

In greater detail, for each of such time sequences SEQ1, SEQ2, . . . , SEQN, the first time interval T1 has a first duration d1, which is usually preset in the design phase of the application program PA, and the second time interval T2 has a second duration d2, which can be variable, as it will become more apparent below.

Anyway, such first duration d1 of the first time interval T1 is advantageously fixed such as to be longer than the second duration d2 relating to the second time interval T2.

Following the connection of the portable devices M1, M2, M3 to the processing equipment 102 of the service center 101, through the Internet 100, the method provides a step 304 of sending, by the processing equipment 102, a synchronization signal S1 to the portable devices M1, M2, M3 in order to synchronize them. For example, such a synchronization signal S1 is indicative of a first time sequence SEQ1 generated by the processing equipment 102, particularly, of the actual or effective time sequence at the time of the connection of the portable devices M1, M2, M3 to the service.

The method 300 then provides a step 305 of sending one or more multimedia contents (photos, videos and the like) to the processing equipment 102 during the first time interval T1 of the first time sequence SEQ1, by the at least one user U1 of the plurality of users through his/her own synchronized portable device M1. Such multimedia contents can be either pictures/videos acquired by the user U1 in “real time”, i.e. after establishing the connection to the internet 100, or pictures/videos acquired some time before and then stored in the portable device M1 of user U1.

At this stage, the method 300 provides for a selection 306, by the processing equipment 102, of a multimedia content specimen among said one or more multimedia contents received during the first time interval T1 of the first time sequence SEQ1. Advantageously, such selection step is performed during the second time interval T2 of the same first time sequence SEQ1, following the first interval T1.

According to a preferred embodiment, such selection of a multimedia content specimen comprises a step of associating a respective first identification ID1i (with i=1, 2, . . . , n) to one or more multimedia contents sent by the at least one user U1 by means of the processing equipment 102. Particularly, such first identification ID1i is generated in order to rename each multimedia content received by the processing equipment l02. Still more particularly, such first identification IDli is generated randomly.

With reference to FIG. 2, a step of storing the one or more renamed multimedia contents in a first area 206 of the memory unit 204 of the processing equipment l02 is also provided. Such first area 206 is representative of an array which includes such first identifications IDli of the multimedia contents.

Moreover, for each of such one or more stored multimedia contents, a step of incrementing a counter CONT is provided. Such counter CONT is suitable to provide, at the end of the first time interval Tl of the first time sequence SEQl, an integer number N representing the total number of multimedia contents which have been stored.

The selection step of the method also comprises a generation step, by means of the processing equipment l02, of a first random number RANl between l and the integer number N returned by the counter CONT.

At this stage, the processing equipment l02 is suitable to provide the multimedia content associated to said first random number RAN1 to the multimedia contents selection unit 103 of the service center 101 associated to the processing equipment 102.

In an embodiment, such a multimedia contents selection unit 103 is configured to generate an approval Sa or disapproval Sd signal of the selected multimedia content based on an evaluation of the parameters of the multimedia content itself.

In an exemplary embodiment, in case of a selection unit 103 comprising a personal computer suitable to operate autonomously based on a respective preinstalled program, such a selection unit 103 is configured to generate the approval Sa/disapproval Sd signal based on a comparison of quantitative properties characterizing the multimedia content itself with preset reference values.

In another exemplary embodiment, where the selection unit 103 is implemented by a display unit of the multimedia content connected to the processing equipment 102 and associated to an operator, such an operator is configured to enable the generation of the approval Sa/disapproval Sd signal of the selected multimedia content based on a subjective evaluation.

In case of a multimedia contents selection performed by a personal computer 103, the second duration d2 of the second time interval T2 ranges between about 1 msec and 20 msec, preferably 10 msec.

In case of selection of multimedia contents performed by the operator, the second duration d2 of the second time interval T2 ranges between about 1 sec e 10 sec, preferably 5 sec.

It should be noted that, following the generation of the disapproval Sd signal of the selected multimedia content by the multimedia contents selection unit 103, the method provides for the repetition of the step of generating the first random number RAN1 and the step of providing the multimedia content associated to such first random number. In other words, a new first random number RAN1 is generated by the processing equipment 102, and the multimedia content associated to such a new first random number RAN1 is sent to the multimedia contents selection unit 103. Such step is repeated cyclically until the approval Sa signal is generated by the multimedia contents selection unit 103.

In an embodiment, the method also comprises a step of deleting, following the generation of the approval Sa signal of the multimedia content, all the multimedia contents stored but not selected during the first time interval T1 of the first time sequence SEQ1. Advantageously, such a deleting happens at the end of the second time interval T2 of the same first time sequence SEQ1.

With reference to FIG. 3, the method 300 advantageously comprises a step of providing 307 the selected multimedia content specimen CS on the portable devices M1, M2, M3 of users U1, U2, U3 connected to the processing equipment 102 during a respective first time interval T1 of a second time sequence SEQ2, following the first sequence SEQ1.

In greater detail, such step comprises a step of storing the first identification of the selected multimedia content specimen, for example indicated with ID1s, in a second area 205, or public area, of the memory unit 204 of the processing equipment 102.

Moreover, it is provided for an access step, by the first application program PG of the processing equipment 102 to such a second area 205 of the memory unit 204 in order to read such first identification ID1s of the selected multimedia content specimen. Particularly, such first application program PG is stored in a third area 207 of the memory unit 204.

There follows a step of the method 300 where the multimedia content CS corresponding to such first identification ID1s is made available to all the connected users U1, U2, U3.

Advantageously, such step of making available the selected multimedia content CS, comprises sending such content in push mode by means of the processing equipment 102 to the portable devices M1, M2, M3, wherein the multimedia content notification reaches the recipient without the latter having to perform any operation. In order for the notification to reach the recipients and for these to be informed the application program PA requires to be enabled, in other words to be working in the background on the portable device, and that the latter is connected to the Internet 100. It must be noticed that the notification mode of the push type is known to those skilled in the art.

In an embodiment, it is also provided that, in case the application program PA is not active, but only stored in the portable device, the system still provides information indicative of the presence of a multimedia content, through a further push notification.

It should be noticed that, with respect to the previous push notification mode, such a further push notification relative to the case where the application program PA is not active, provides for an alert signal comprising a message.

In an exemplary embodiment of the method, following the synchronization between the processing equipment 102 and the portable devices M1, M2, M3, the method comprises the further step of making available a selected multimedia content to each portable device M1, M2, M3 during a further time sequence SEQA which has been generated before the first time sequence SEQ1. Particularly such further time sequence SEQA is the time sequence just preceding the first sequence.

In the specific case of FIG. 4A, on a display of each portable device M1, M2, M3 connected to the processing equipment 102 the selected photo 401 is made available, through a respective graphical user interface or GUI 400, during the further time sequence SEQA preceding the first sequence SEQ1 wherein the connection to the network 100 has been established.

It should be noticed that such a graphical interface 400 also reports a timing information 402 (in the form of a countdown) indicative of the first duration d1 of the first time interval T1.

Moreover, said graphical interface 400 can comprise, for example, a first icon 403 selectable by the user U1 in order to enable the acquisition of a photo image with the portable device M1, and a second icon 404 selectable in order to allow the user U1 to navigate an interactive menu 405 of the application program PA.

Particularly, such interactive menu 405, shown in greater detail in FIG. 4B, comprises respective arrays 406, 407, 408 of photo images gathered based on appreciation votes expressed by the users. For example, the first array 406 includes those photos most appreciated by the users, the second array 407 those most seen by the users and the third 408 those less appreciated.

The method of the invention provides the possibility for each user U1, U2, U3 to vote the photo 401 both during the first time interval T1 of the first sequence SEQ1 and during the second time interval T2. Particularly, each portable device is configured to send a vote signal Svi (i=1, 2, 3) to the processing equipment 102 which updates a respective record associated to said photo 401 based on the received signals.

It should be noticed that, particularly, each photo 401 is associated, for any vote type, to respective counters, particularly two counters, indicative of positive votes and negative votes expressed by the users. Such counters are incremented starting from an initial value 0, following the approval/disapproval votes shown by the users. For example, the counters of a first picture or picture 1 comprise initially 0 positive votes and 0 negative ones. When a user expresses an approval vote for picture 1, the first counter is incremented and the second stays at the value zero. Each photo can also include a further counter, which is incremented each time the photo is visualized.

With reference to the example of FIG. 4B, each photo included in the first array 406 also reports, in addition to acquisition date and time, the number of approval votes received by the users.

In an alternative embodiment of the method 300, the step of enabling the application program PA stored in the portable devices M1, M2, M3 comprises a further step of making available to the processing equipment 102 also a first enabling signal S3_{Mi} (with i=1, 2, 3) including a geolocation information IG associated to each portable device M1, M2, M3. Such a geolocation information IG, particularly, is stored by the processing equipment 102.

In view of that, the above-mentioned step of making available the selected multimedia content specimen CS comprises the step of also sending to all the portable devices M1, M2, M3 connected to the processing equipment 102, said geolocation information IG associated to the portable device that sent the multimedia content selected.

The algorithm relative to the method 300 of the invention symbolically ends with an end step ED.

It should be noticed that the first application program PG of the processing equipment 102 is written, for example, in programming language C Sharp. The application program PA stored in the portable devices M1, M2, M3 is written in a programming language chosen in the group of: Objective C, Java.

The method for sharing multimedia contents 300 among users of the present description presents numerous advantages.

In fact, with such method no registration is required to the users U1, U2, U3 because the application program PA stored in the portable devices M1, M2, M3 transfers to the processing equipment 102 the univocal identification IDi of each portable device through the enabling signal S2_{Mi} and at the most also the geolocation information IG of the device through the first enabling signal S3_{Mi}. Such step is substantially transparent for the users of the service. In other words, no particular operation is required from the user except for running the application program PA.

Moreover, unlike the methodologies implemented in the known social networks, having downloaded the application program PA represents an implicit authorization to share the multimedia contents sent to the processing equipment with all the users that have downloaded the same application program. The method of the invention, therefore, does not require an authorization step in order to access the multimedia contents and the corresponding long data insertion steps by the users are also avoided with a considerable reduction in the time required for sharing the multimedia contents.

Moreover, the known social networks require, with the increasing of registered users, more and more resources in terms of memory space of the respective processing equipment in order to store information and data associated with such users.

On the contrary, the method of the invention allows achieving a result equal to that achievable by such social networks, in terms of reachable users, by requiring less resources since the non-selected multimedia contents are periodically deleted, at the end of the second time interval T2 of each time sequence.

To the embodiments of the method described above, those skilled in the art, in order to meet particular needs, will be able to carry out modifications, adjustments and substitutions of elements with others functionally equivalent, without departing from the scope of the following claims. Each characteristic described as being part of a possible embodiment can be carried out independently from the other embodiments described herein.

1. A method for sharing multimedia contents among a plurality of users through a telecommunication network, each user being associated to a respective portable device provided with a module for connection to the telecommunication network, the method comprising the steps of:
storing an application program into a firmware of each portable device, said application program being suitable to interoperate with a first application program of processing equipment of a service center for management of a service of sharing multimedia contents among the users and connected to the telecommunication network;
running said application program stored in each portable device of the plurality of users to connect said portable devices to the processing equipment;
cyclically generating by said processing equipment time sequences, each sequentially comprising a first time interval and a second time interval;
following said connection, sending by said processing equipment a synchronization signal to the portable devices to synchronize the portable devices, said synchronization signal being indicative of a first time sequence generated by the processing equipment;
sending, by at least one user of said plurality of users, one or more multimedia contents to the processing equipment during the first time interval of said first sequence through the synchronized portable device;
selecting, by the processing equipment, a specimen of multimedia content from said one or more multimedia contents received during the first time interval of the first time sequence, said step of selecting being performed during the second time interval of the first time sequence following the first interval;
making available said selected specimen of multimedia content on the portable devices of the users of said plurality who are connected to the processing equipment during a respective first time interval of a second time sequence following the first sequence.

2. The method for sharing multimedia contents according to claim 1, wherein said step of storing further comprises the following steps which are performed only once for each portable device:
downloading said application program by each user from an online virtual shop of applications, music, books and other media on the respective portable device;
enabling said downloaded application program on the basis of an enabling signal sent by the portable devices to the processing equipment.

3. The method for sharing multimedia contents according to claim 2, wherein said online virtual shop of applications, music, books and other media is chosen from the group consisting of:
Google Play Store;
Mac App Store;
Windows Store.

4. The method for sharing multimedia contents according to claim 2, wherein said step of enabling said application program comprises the further steps of:
making available to the processing equipment an univocal identification of each portable device with said enabling signal;
storing, by the processing equipment, said identification of the portable device.

5. The method for sharing multimedia contents according to claim 1, wherein, for each time sequence, the first time interval has a first duration and the second time interval has a second duration, where said first duration is longer than the second duration.

6. The method for sharing multimedia contents according to claim 1, wherein following said synchronization, the method comprises the further step of making available to each portable device connected to the processing equipment, a selected multimedia content during a further time sequence preceding said first time sequence.

7. The method for sharing multimedia contents according to claim 1, wherein said step of selecting a specimen of multimedia content comprises the steps of:
associating, by the processing equipment, to the one or more multimedia contents sent by said at least one user a first identification randomly generated to rename the one or more multimedia contents;
storing the one or more renamed multimedia contents in a first area of a memory unit of the processing equipment;
for each of said one or more stored multimedia contents, incrementing a counter, said counter returning at the end of the first time interval of said first time sequence an integer number representing the total number of stored multimedia contents;
generating, by the processing equipment, a first random number between 1 and said integer number;
making available, by the processing equipment, the multimedia content associated to said first random number to one multimedia contents selection unit of the service center associated to the processing equipment, said selection unit being configured to generate an approval/disapproval signal of the selected multimedia content based on a parameters evaluation of said multimedia content.

8. The method for sharing multimedia contents according to claim 7, further comprising the step of cyclically repeating the steps of generating the first random number and making available the multimedia content associated to said first random number, following generation of the disapproval signal of the multimedia content by the multimedia contents selection unit.

9. The method for sharing multimedia contents according to claim 7, further comprising the step of deleting the stored multimedia contents at the end of the second time interval of said first sequence following generation of the approval signal of the multimedia content by the multimedia contents selection unit.

10. The method for sharing multimedia contents according to claim 7, wherein said multimedia contents selection unit is embodied by a first programmable processing device connected to said processing equipment and configured to generate said approval/disapproval signal of the selected multimedia content based on a comparison of quantitative properties which characterize the multimedia content with preset reference values.

11. The method for sharing multimedia contents according to claim 7, wherein said multimedia contents selection unit is embodied by a display unit of the multimedia content connected to the processing equipment and associated to an operator, said operator being configured to enable the generation of the approval/disapproval signal of the selected multimedia content based on a subjective evaluation.

12. The method for sharing multimedia contents according to claim 10, wherein the second duration of the second time interval is between 1 msec and 20 msec, in the case of multimedia contents selection performed by the first programmable processing device.

13. The method for sharing multimedia contents according to claim 11, wherein the second duration of the second time interval is between 1 sec and 10 sec, in the case of multimedia contents selection performed by the operator.

14. The method for sharing multimedia contents according to claim 1, wherein said step of making available the specimen of selected multimedia content, comprises the steps of:
storing said first identification of the selected multimedia content specimen in a second area of the memory unit of the processing equipment;
accessing, by the first application program of the processing equipment to said second area of the memory unit to read said first identification of selected multimedia content specimen;
making available the multimedia content corresponding to the first identification to all the connected users.

15. The method for sharing multimedia contents according to claim 4, wherein said step of enabling said application program comprises the further steps of:
making available to the processing equipment a first enabling signal including a geolocation information associated to the portable device;
storing, by the processing equipment, said geolocation information.

16. The method for sharing multimedia contents according to claim 16, wherein said step of making available the selected multimedia content specimen comprises the step of sending to all the portable devices connected to the processing equipment, the geolocation information associated to the portable device which sent the selected multimedia content.

17. The method for sharing multimedia contents according to claim 1, wherein the first application program of the processing equipment is written in C Sharp programming language, the application program stored in the portable devices is written in a programming language chosen from the group consisting of: Objective C, Java.

18. A system for the multimedia contents sharing among a plurality of users through a telecommunication network, comprising:
a plurality of portable devices each portable device being associated to a respective user and provided with a module for connection to the telecommunication network;
a processing equipment associated to a service center for management of a multimedia contents sharing service among the users, said processing equipment and said portable devices being configured to implement the method for sharing multimedia contents described by claim 1.
